(19) United States
(12) Patent Application Publication
(10) Pub. No.: US 2005/0236892 A1
(43) Pub. Date: Oct. 27, 2005

(54) Hydraulic braking pressure generating apparatus for vehicles

(76) Inventor: Akihito Kusano, Toyota City (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 11/110,896

(22) Filed: Apr. 21, 2005

(30) Foreign Application Priority Data
Apr. 27, 2004 (JP) 2004-131801
Apr. 27, 2004 (JP) 2004-131803

(51) Int. Cl. B60T 8/40

(52) U.S. Cl. 303/116.1; 303/155

(57) ABSTRACT

A pressure generating apparatus includes a master cylinder and a stroke simulator which has a pressure chamber communicated with a first master chamber, an atmospheric chamber communicated with a reservoir, and a piston member urged by a resilient member, and which absorbs brake fluid in response to the hydraulic pressure discharged from the first master chamber, to provide a stroke for a first master piston. The atmospheric chamber of the simulator is communicated with the reservoir when a second master piston member is placed in an initial position thereof, and blocks the communication between them, when the second master piston is advanced by a predetermined distance or more from the initial position.

This application claims priorities under 35 U.S.C. Sec. 119 to Nos.2004-131801 and 2004-131803filed in Japan on Apr. 27, 2004, the entire contents of which are herein incorporated by reference.

### BACKGROUND OF THE INVENTION

1. Field of the invention

The present invention relates to a hydraulic braking pressure generating apparatus for vehicles, and more particularly, the hydraulic braking pressure generating apparatus provided with a braking stroke simulator.

2. Description of the Related Arts

Heretofore, there are known various hydraulic braking pressure generating apparatuses for vehicles, which are provided with braking stroke simulators. In general, hydraulic pressure generated by a pressure source is controlled by a pressure control device including the pressure source in response to operation of a manually operated braking member, to be supplied into wheel brake cylinders, with the communication between a master cylinder and wheel brake cylinders being blocked. When the pressure control device has come to be abnormal, the master cylinder is communicated with the wheel brake cylinder, to discharge the hydraulic pressure into the wheel brake cylinders in response to braking operation force of the manually operated braking member.

Also, there has been known heretofore an apparatus, wherein a first piston member is slidably accommodated in a cylinder housing to be moved back and forth in response to operation of a manually operated braking member, and a second piston member is slidably accommodated in the cylinder housing for defining a first master pressure chamber between the first piston member and the second piston member, and defining a second master pressure chamber between the second piston member and the cylinder housing. The apparatus includes a stroke simulator having a simulator pressure chamber which is communicated with the first master pressure chamber, a simulator atmospheric pressure chamber which is communicated with an atmospheric pressure reservoir, and a piston member which is urged by a resilient member toward the simulator pressure chamber, so that the stroke simulator absorbs brake fluid of an amount determined in response to the hydraulic pressure discharged from the first master pressure chamber, to provide a stroke for the first piston member in response to braking operation force of the manually operated braking member. And, a communication control device is provided for communicating the simulator atmospheric pressure chamber with the atmospheric pressure reservoir when the second piston member is placed in an initial position thereof, and blocking the communication between the simulator atmospheric pressure chamber and the atmospheric pressure reservoir, when the second piston member is advanced by a predetermined distance or more from the initial position thereof.

As for the communication control device, there is disclosed a valve device provided with a seal member arranged at a second piston in Japanese Patent Laid-open publication (PCT) 2003-528768, which corresponds to the U.S. Patent Application Publication No. 2003/0098611 A 1, for example, wherein a seal of a cup-like cross section is mounted on the second piston, and a channel is associated with the seal member.

With respect to the apparatus as described above, there is disclosed a pedal feel emulator in the U.S. Pat. No. 6,267,456 B 1, wherein a structure having a passage, valve and cam is disclosed in FIGS. 1-3, and another structure having the passage and a piston with a seal member is disclosed in FIGS. 4-6, to act as the communication control device as described above.

However, in the case where the seal member as disclosed in the United States Patent Publication, or the seal member as disclosed in FIGS. 4-6 of the United States Patent, is used for the communication control device, after the communication between the simulator atmospheric pressure chamber and the atmospheric pressure reservoir was blocked, the seal member has to slide in the cylinder housing. Therefore, a high accuracy is required for working the cylinder housing, when the inner peripheral surface thereof is formed, so that the apparatuses will be expensive.

### SUMMARY OF THE INVENTION

Accordingly, it is an object of the present invention to provide a hydraulic braking pressure generating apparatus for vehicles, which is provided with a master cylinder and a braking stroke simulator, together with a pressure control device having a high reliability, and which can be produced at a low cost.

In order to accomplish the above and other objects, the hydraulic braking pressure generating apparatus is provided with a first piston member which is slidably accommodated in a cylinder housing to be moved back and forth in response to operation of a manually operated braking member, and a second piston member which is slidably accommodated in the cylinder housing for defining a first master pressure chamber between the first piston member and the second piston member, and defining a second master pressure chamber between the second piston member and the cylinder housing, and provided with a stroke simulator. The stroke simulator includes a simulator pressure chamber which is communicated with the first master pressure chamber, a simulator atmospheric pressure chamber which is communicated with an atmospheric pressure reservoir, and a piston member which is urged by a resilient member toward the simulator pressure chamber. And, the stroke simulator absorbs brake fluid of an amount determined in response to the hydraulic pressure discharged from the first master pressure chamber, to provide a stroke for the first piston member in response to braking operation force of the manually operated braking member. The apparatus is further provided with a communication control device which communicates the simulator atmospheric pressure chamber with the atmospheric pressure reservoir when the second piston member is placed in an initial position thereof, and blocks the communication between the simulator atmospheric pressure chamber and the atmospheric pressure reservoir, when the second piston member is advanced by a predetermined distance or more from the initial position thereof. The communication control device includes a seal member which is disposed in the cylinder housing, and a communication passage which is formed on the second piston member. According to this apparatus, the communication control device communicates the simulator atmospheric pressure chamber with the atmospheric pressure reservoir through the communication passage, when the second piston member is placed in the initial position thereof, and the communication control device separates the communication passage from one of the simulator atmospheric pressure chamber and the atmospheric pressure reservoir by the seal member, when the second piston member is advanced from the initial position thereof by the predetermined distance or more, to block the communication between the simulator atmospheric pressure chamber and the atmospheric pressure reservoir.

In the apparatuses as described above, preferably, the second piston member is formed with a small diameter portion to provide a step between a main body portion of the second piston member and the small diameter portion, and a clearance is formed by the step to provide the communication passage.

The communication passage may include a longitudinal communication groove, which is formed around a part of the outer peripheral surface of the second piston member. Or, the communication passage may include a longitudinal cut-out section, which is formed around a part of the outer peripheral surface of the second piston member. Or, the communication passage may include a communication hole, which is formed to penetrate the second piston member in a direction crossing a longitudinal axis thereof.

Furthermore, the apparatus may be provided with a communication control device which communicates the simulator atmospheric pressure chamber with the atmospheric pressure reservoir when the second piston member is placed in an initial position thereof, and blocks the communication between the simulator atmospheric pressure chamber and the atmospheric pressure reservoir, when the second piston member is advanced by a predetermined distance or more from the initial position thereof. The communication control device includes a seal member which is disposed in the cylinder housing and applied with the hydraulic pressure in the second master pressure chamber when the simulator atmospheric pressure chamber is communicated with the reservoir, and a communication hole which is formed to penetrate the second piston member in a direction crossing a longitudinal axis thereof. And, the communication control device communicates the simulator atmospheric pressure chamber with the atmospheric pressure reservoir through the communication hole, when the second piston member is placed in the initial position thereof, and the communication control device separates the communication hole from one of the simulator atmospheric pressure chamber and the atmospheric pressure reservoir by the seal member, when the second piston member is advanced from the initial position thereof by the predetermined distance or more, to block the communication between the simulator atmospheric pressure chamber and the atmospheric pressure reservoir.

In the apparatuses as described above, the stroke simulator may be accommodated in the second piston member.

### BRIEF DESCRIPTION OF THE DRAWINGS

The above stated object and following description will become readily apparent with reference to the accompanying drawings, wherein like reference numerals denote like elements, and in which:

FIG. 1 is a sectional view of a hydraulic braking pressure generating apparatus for vehicles according to an embodiment of the present invention;

FIG. 2 is a schematic block diagram of a hydraulic brake apparatus having a hydraulic braking pressure generating apparatus according to an embodiment of the present invention;

FIG. 3 is a sectional view of a master piston, with its main body portion sectioned in a direction perpendicular to its longitudinal axis according to the embodiment as shown in FIG. 1;

FIG. 4 is a sectional view of another master piston, with its main body portion sectioned in a direction perpendicular to its longitudinal axis according to the embodiment as shown in FIG. 1;

FIG. 5 is a sectional view of a hydraulic braking pressure generating apparatus for vehicles according to another embodiment of the present invention;

FIG. 6 is a sectional view of a hydraulic braking pressure generating apparatus for vehicles according to a further embodiment of the present invention;

FIG. 7 is a sectional view of a hydraulic braking pressure generating apparatus for vehicles according to a yet further embodiment of the present invention;

FIG. 8 is a sectional view of a hydraulic braking pressure generating apparatus for vehicles according to a yet further embodiment of the present invention;

FIG. 9 is a sectional view of another master piston along its longitudinal axis according to the embodiment as shown in FIG. 8;

FIG. 10 is a schematic block diagram of a hydraulic brake apparatus having the hydraulic braking pressure generating apparatus according to the embodiment as shown in FIG. 8; and

FIG. 11 is a sectional view of a hydraulic braking pressure generating apparatus for vehicles according to a yet further embodiment of the present invention.

### DESCRIPTION OF THE PREFERRED EMBODIMENTS

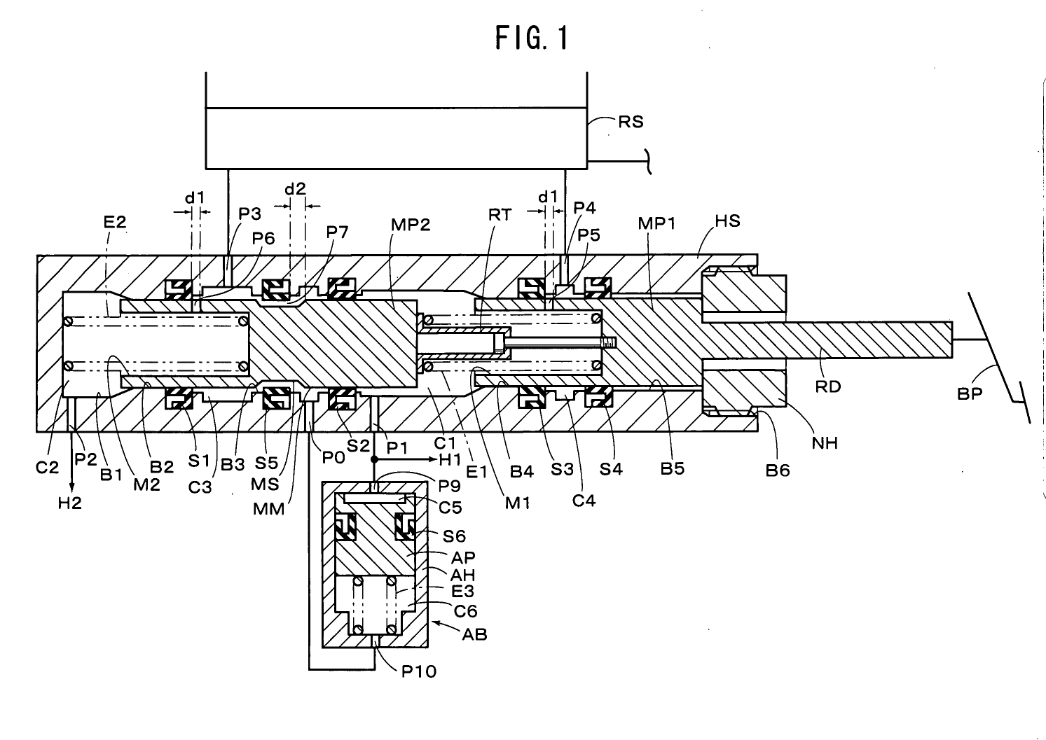

Referring to FIG. 1, there is illustrated a hydraulic braking pressure generating apparatus according to an embodiment of the present invention, wherein a first master piston MP1 served as the first piston member is slidably accommodated in a cylinder housing HS (hereinafter, simply referred to as housing HS), and connected to a brake pedal BP served as the manually operated braking member. Also, a second master piston MP2 served as the second piston member is slidably accommodated in the housing HS, so that a first master chamber Cl is defined between the first master piston MP1 and the second master piston MP2, and a second master chamber C2 is defined between the second master piston MP2 and a front end of the housing HS. To be communicated with the first master chamber Cl, there is provided a stroke simulator AB, which is adapted to absorb brake fluid of the amount determined in response to the hydraulic pressure discharged from the first master chamber C1, and which provides a stroke for the first master piston MP1 in response to braking operation force of the brake pedal BP.

The housing HS is closed in its front end (left in FIG. 1) to be formed in a cylinder with a bottom, and formed with a cylinder bore having a recess B1, and a stepped bore of a small diameter bore B2, a stepped large diameter bore B3, a small diameter bore B4 and a large diameter bore B5. At the rear end of the housing HS, there is formed an open end portion B6 with threaded grooves formed on its inner surface. On the inner wall of the cylinder bore, formed are annular grooves for holding annular seal members S1-S5 having a cup-like cross section, respectively. An atmospheric pressure chamber C3 is defined between the annular seal members S1 and S2, and an atmospheric pressure chamber C4 is defined between the annular seal members S3 and S4. The housing HS may be made of a single metallic member, because those annular grooves and the large diameter bore B3 or the like can be formed by boring the housing HS along the longitudinal axis thereof. On the side wall of the housing HS, there are formed ports P0 and P1 opening into a front section and a rear section of the seal member S5 in the large diameter bore B3, respectively, a port P2 opening into the second master chamber C2 in the recess B1, a port P3 opening into the atmospheric pressure chamber C3, and a port P4 opening into the atmospheric pressure chamber C4. The ports P3 and P4 are communicated with an atmospheric pressure reservoir RS (hereinafter, simply referred to as reservoir RS).

As for the first master piston MP1, there are formed at its front end a recess M1 opening forward, and formed at its rear end a rod RD extending backward. On the side wall of the first master piston MP1, there is formed a port P5 opening into the recess M1. The second master piston MP2 is formed with a recess M2 opening forward, and formed at a middle portion thereof with a small diameter portion MS to form a step between the same and its main body portion MM, thereby to provide a communication passage P7. Also, on the side wall of the second master piston MP2, there is formed a port P6 opening into the recess M2. The small diameter portion MS of the second master piston MP2 may be formed along the whole length of a portion extending from its front end to the front end of the second master piston MP2 (leftward in FIG. 1). In this case, therefore, instead of the annular groove being formed by the step as shown in FIG. 1, only the step is formed between the small diameter portion MS and the main body portion MM.

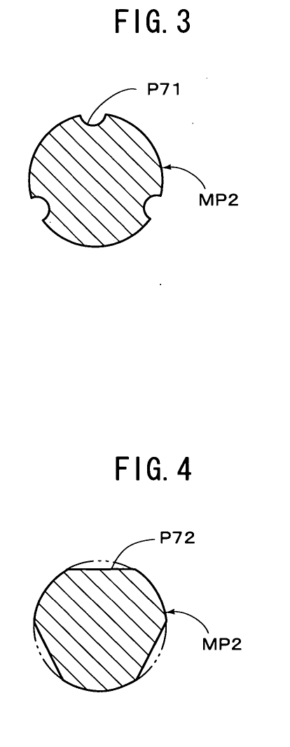

As for the communication passage P7, longitudinal communication grooves P71 may be formed as shown in FIG. 3, around a part of the outer peripheral surface of the second master piston MP2. Or, longitudinal cut-out sections P72 may be formed as shown in FIG. 4, around a part of the outer peripheral surface (as indicated by two-dotted chain line in FIG. 4) of the second master piston MP2 to be cut out longitudinally. Between the first and second master pistons MP1 and MP2, a compression spring El is mounted through a retainer RT to act as a return spring, and a compression spring E2 is accommodated in the recess M2 to act as a return spring, as well.

According to the present embodiment, there is provided a stroke simulator AB, which absorbs brake fluid of the amount determined in response to the hydraulic pressure discharged from the first master chamber Cl, and provides a stroke of the first master piston MP1 in response to braking operation force of the brake pedal BP. And, an operative state of the stroke simulator AB or an inoperative state thereof (prevention of fluid from being drained) is selectively provided, by means of the seal member S5, which is disposed between the seal members S1 and S2 in the housing HS, and the communication passage P7, which is formed on the small diameter portion MS at the position to be faced with the seal member S5 when the second master piston MP2 is placed on its initial position.

The stroke simulator AB includes a cylindrical housing AH, and a piston member AP fluid-tightly and slidably received therein through a seal member S6, to define a simulator hydraulic pressure chamber C5 (hereinafter simply referred to as simulator pressure chamber C5) and a simulator atmospheric pressure chamber C6 (hereinafter simply referred to as atmospheric pressure chamber C6). The stroke simulator AB is so constituted that the piston member AP is urged by a compression spring E3 accommodated in the atmospheric pressure chamber C6, so as to reduce a volume of the simulator pressure chamber C5. Furthermore, the housing AH is formed with a port P9 for communicating the simulator pressure chamber C5 with the first master chamber C1 through the port P1, and formed with a port P10 for communicating the atmospheric pressure chamber C6 with the port PO formed between the seal members S2 and S5.

Next will be explained the parts of the master cylinder as described above, according to an example of a sequence of steps for assembling them. At the outset, the annular seal members S1-S5 are held in the annular grooves of the housing HS. Next, the compression spring E2 is received in the recess B1 of the housing HS and the recess M2 of the second master piston MP2. Then, the second master piston MP2 with the seal members S1 and S2 mounted thereon is fluid-tightly and slidably received into the cylinder bore to define the second master chamber C2 in front of the second master piston MP2. With the compression spring E1 mounted through the retainer RT in the recess M1, the first master piston MP1 is fluid-tightly and slidably fitted into the cylinder bore through the seal members S3 and S4, to define the first master chamber Cl between the first and second master pistons MP1 and MP2. With the first and second master pistons MP1 and MP2 accommodated in the cylinder bore of the hosing HS, screwed into the open end portion B6 is a nut-like stopper NH with threaded grooves formed on its outer peripheral surface, to prevent the first and second master pistons MP1 and MP2 from being moved rearward by the biasing force of the compression spring E2.

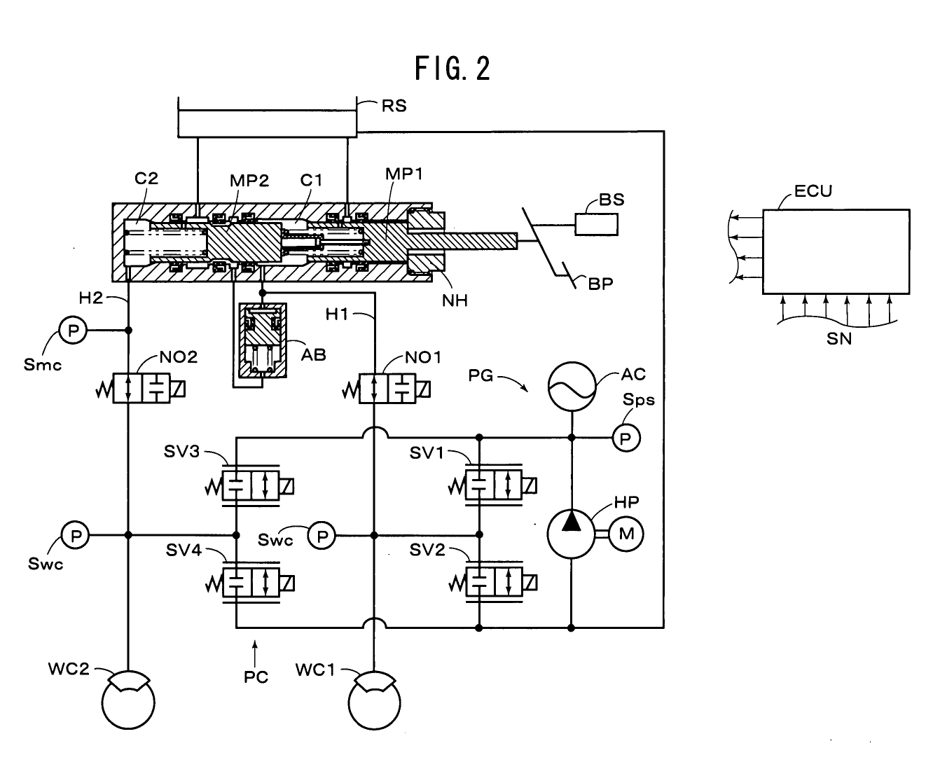

With those parts assembled as described above, the first master chamber Cl and the second master chamber C2 are defined in front of the first master piston MP1 and second master piston MP2, respectively, in the housing HS, to be communicated with the wheel brake cylinder WC1 and WC2 as shown in FIG. 2, through the ports P1 and P2 via hydraulic pressure circuits Hi and H2, respectively. When the first and second master pistons MP1 and MP2 are placed in their initial positions as shown in FIG. 1, the first and second master chambers C1 and C2 are communicated with the atmospheric pressure chambers C4 and C3 through the ports P5 and P6, and finally communicated with the reservoir RS through the ports P4 and P3, respectively.

When the second master piston MP2 is placed in its initial position as shown in FIG. 1, the small diameter portion MS is faced with the seal member S5, so that the atmospheric pressure chamber C3 is communicated with the atmospheric pressure chamber C6 of the stroke simulator AB through the communication passage P7 (and, the ports P0 and P10). According to the embodiment as shown in FIG. 3 or FIG. 4, communication grooves P71 (in FIG. 3) or cut-out sections P72 (in FIG. 4) are formed around a specific part of the outer peripheral surface of the second master piston MP2 to provide the communication passage P7, and the seal member S5 is in contact with the other outer peripheral surface of the second master piston MP2, so that the atmospheric pressure chamber C3 is communicated with the atmospheric pressure chamber C6 of the stroke simulator AB through the communication passage P7 of the communication grooves P71 or cut-out sections P72 (and, the ports P0 and P10). And, when the second master piston MP2 is advanced from its initial position by a first stroke dl (port idle) or more, the opening area of the port P6 is closed by the seal member S1, thereby to block the communication between the second master chamber C2 and the atmospheric pressure chamber C3. Likewise, when the first master piston MP1 is advanced from its initial position by the first stroke dl (port idle) or more, the opening area of the port P5 is closed by the seal member S3, thereby to block the communication between the first master chamber C1 and the atmospheric pressure chamber C4. The pressure chamber C5 is always communicated with the first master chamber C1 through the ports P1 and P9.

With the first master piston MP1 being advanced, the piston member AP is pushed against the biasing force of the compression spring E3 to expand the simulator pressure chamber C5, a stroke is given to the first master piston MP1. Thereafter, the atmospheric pressure chamber C6 will be communicated with the atmospheric pressure chamber C3 through the communication passage P7 (and, the ports PO and P10) and finally communicated with the reservoir RS, to actuate the stroke simulator AB, until the second master piston MP2 will be advanced from its initial position by a predetermined distance (second stroke d2) so that its main body MM will contact the seal member S5. And, when the second master piston MP2 is advanced from its initial position by the second stroke d2 or more, the communication passage P7 is separated from the atmospheric pressure chamber C6 by the seal member S5, whereby the communication between the atmospheric pressure chamber C6 and the reservoir RS is blocked. Therefore, the communication control device according to the present invention is constituted by the communication passage P7 as shown in FIG. 1 and the seal member S5, or the communication grooves P71 as shown in FIG. 3 and the seal member S5, or the cut-out sections P72 as shown in FIG. 4 and the seal member S5.

The hydraulic braking pressure generating apparatus as described above is provided to constitute a hydraulic brake apparatus for a vehicle as shown in FIG. 2, wherein a normally open electromagnetic switching valve NO1 is disposed in the hydraulic pressure circuit Hl, so that the apparatus is connected to a wheel brake cylinder (indicated by WC1) in one circuit through the switching valve NO1, and it is also connected to a pressure source PG for generating a certain hydraulic pressure irrespective of the braking operation of the vehicle driver. Likewise, a normally open electromagnetic switching valve N02 is disposed in the hydraulic pressure circuit H2, so that the apparatus is connected to a wheel brake cylinder (indicated by WC2) in the other one circuit through the switching valve N02, and it is also connected to the pressure source PG. The pressure source PG includes an electric motor M controlled by an electronic control unit ECU, and a hydraulic pressure pump HP, which is driven by the electric motor M, and whose inlet is connected to the reservoir RS, and whose outlet is connected to an accumulator AC. According to the present embodiment, a pressure sensor Sps is connected to the outlet, and the detected pressure is monitored by the electronic control unit ECU. On the basis of the monitored result, the motor M is controlled by the electronic control unit ECU to keep the hydraulic pressure in the accumulator AC between predetermined upper and lower limits.

The accumulator AC is connected to a hydraulic passage between the switching valve NO1 and the wheel brake cylinder WC1 in the hydraulic pressure circuit Hi, through a first linear solenoid valve SV2 of a normally closed type, to regulate the hydraulic pressure discharged from the pressure source PG and supply it to the wheel brake cylinder WC1. Also, the reservoir RS is connected to the hydraulic passage between the switching valve NO1 and wheel brake cylinder WC1, through a second linear solenoid valve SV2 of a normally closed type, to reduce the pressure in the wheel brake cylinder WC1 and regulate it. Likewise, in the hydraulic pressure circuit H2, the accumulator AC is connected to a hydraulic passage between the switching valve N02 and the wheel brake cylinder WC2, through a first linear solenoid valve SV3 of a normally closed type, to regulate the hydraulic pressure discharged from the pressure source PG and supply it to the wheel brake cylinder WC2. Also, the reservoir RS is connected to the hydraulic passage between the switching valve N02 and wheel brake cylinder WC2, through a second linear solenoid valve SV4 of a normally closed type, to reduce the pressure in the wheel brake cylinder WC2 and regulate it. According to the present embodiment, therefore, the pressure control device PC is formed by the pressure source PG, first linear solenoid valves SV1 and SV3, second linear solenoid valves SV2 and SV4, electronic control unit ECU, and sensors as described hereinafter.

According to the present embodiment, the pressure sensor Smc is disposed at the upstream of the switching valve N02 in the hydraulic pressure circuit H2, for example, and the pressure sensor Swc is disposed at the downstream thereof and at the downstream of the switching valve NO1 in the hydraulic pressure circuit Hl. On the brake pedal BP, the stroke sensor BS is operatively connected to detect its stroke. The signals detected by the sensors as described above are fed to the electronic control unit ECU. Thus, the hydraulic braking pressure discharged from the master chamber C2, the hydraulic braking pressure in the wheel brake cylinders WC2 and WC1, and the stroke of the brake pedal BP are monitored by those sensors. The pressure sensor Smc may be disposed in the hydraulic pressure circuit Hl, or in both of the hydraulic pressure circuits. Furthermore, in order to achieve those controls including the anti-skid control or the like, the sensors SN such as wheel speed sensors, acceleration sensor or the like have been provided, so that the signals detected by them are fed to the electronic control unit ECU.

Hereinafter, explained is operation of the hydraulic brake apparatus having the hydraulic braking pressure generating apparatus as constituted above. At the outset, in the case where the pressure control device PC is normal, the switching valves NO1 and NO2 as shown in FIG. 2 are energized to be placed in their closed positions, so that the hydraulic pressure circuits H1 and H2 are shut off, and the hydraulic pressure discharged from the pressure source PG is supplied to the wheel brake cylinders WC1 and WC2 in response to operation of the brake pedal BP, on the basis of the value detected by the stroke sensor BS and the pressure sensor Smc. That is, the electric current fed to the first linear solenoid valves SV1 and SV3, and the second linear solenoid valves SV2 and SV4 will be controlled respectively, so that the wheel cylinder pressure detected by the pressure sensor Swc will be made equal to the desired wheel cylinder pressure. Consequently, the hydraulic pressure controlled by the pressure control device PC in response to operation of the brake pedal BP is supplied to the wheel brake cylinders WC1 and WC2. In this case, the second master piston MP2 is advanced only by a distance approximately equal to the port idle (first stroke dl), and will not be moved after the communication between the second master chamber C2 and the atmospheric pressure chamber C3 has been shut off, whereas only the first master piston MP1 will be advanced. In this case, the first master chamber C1 and the simulator pressure chamber C5 have been communicated with each other, and the atmospheric pressure chamber C6 of the stroke simulator AB has been communicated with the atmospheric pressure chamber C3 through the communication passage P7, which is defined by a clearance of the step formed between the small diameter portion MS and main body portion MM (the communication grooves P71 in FIG. 3, or the cut-out sections P72 in FIG. 4), and finally communicated with the reservoir RS. Therefore, if the braking operation force applied to the piston member AP of the stroke simulator AB is increased in response to operation of the brake pedal BP to exceed the mounting load of the compression spring E3, the compression spring E3 is compressed to provide the stroke of the first master piston MP1 in response to the braking operation force.

On the contrary, in the case where the pressure control device PC including the pressure source PG and the like comes to be abnormal, the switching valves NO1 and N02 are de-energized (turned off) to be placed in their open positions, so that the hydraulic pressure circuits Hl and H2 are in their communicated states as shown in FIG. 2. At the same time, the first linear solenoid valves SV1 and SV3 and the second linear solenoid valves SV2 and SV4 are de-energized (turned off) to be placed in their closed positions, respectively, so that the hydraulic pressure will not be supplied from the pressure source PG to the wheel brake cylinders WC1 and WC2. In this state, therefore, when the brake pedal BP is depressed, to advance the second master piston MP2 by the second stroke (d2) or more from the initial position in response to operation of the brake pedal BP, its main body portion MM will contact the seal member S5, to block the communication between the atmospheric pressure chamber C3 and the atmospheric pressure chamber C6 in the stroke simulator AB. Consequently, the first and second master pistons MP1 and MP2 will be advanced to compress the first and second master chambers C1 and C2, respectively, without the stroke simulator AB being operated, thereby to discharge the hydraulic pressure to the hydraulic pressure circuits H1 and H2 in response to operation of the brake pedal BP.

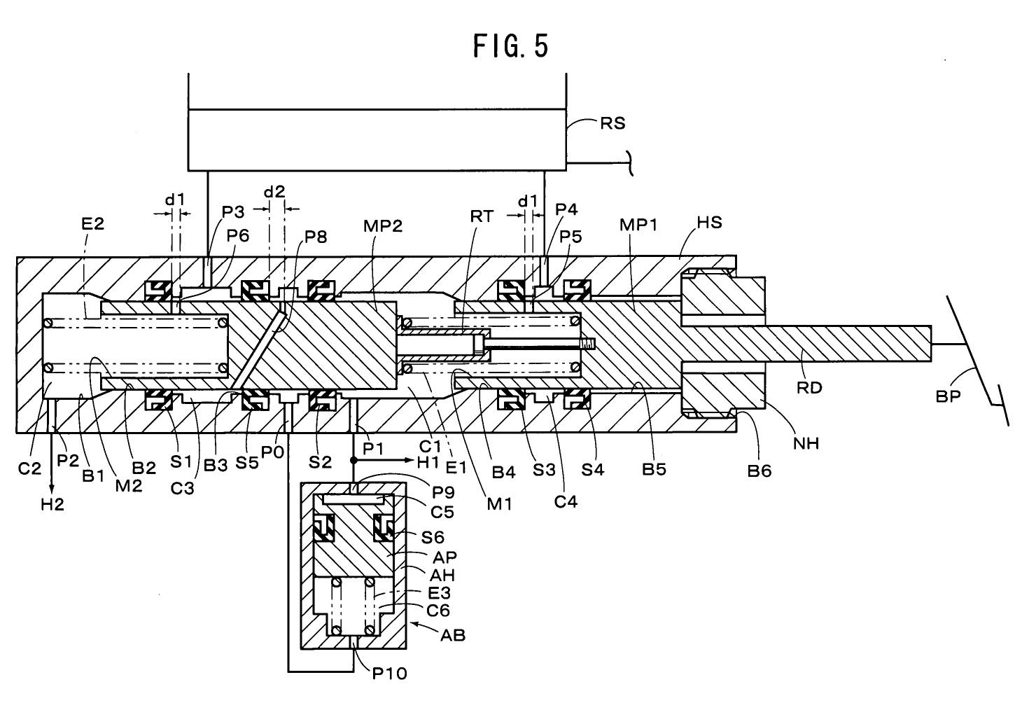

Next, another embodiment of the present invention is explained referring to FIG. 5, wherein structural elements equivalent to those described in FIG. 1 are designated by corresponding reference numerals. According to the present embodiment, as for the communication passage of the present invention, a communication hole P8 is formed to penetrate the second master piston MP2 in a direction crossing its longitudinal axis (i.e., offset radial direction). When the second master piston MP2 is placed in its initial position as shown in FIG. 5, the seal member S5 is in contact with the outer peripheral surface of the other part of the peripheral surface of the main body portion with the communication hole P8 formed on one part of it, to be opened at the front and rear sections of the seal member S5 along its longitudinal axis, so that the atmospheric pressure chamber C6 of the stroke simulator AB is communicated with the atmospheric pressure chamber C3 through the communication hole P8 (and, the ports P0 and P10) and finally communicated with the reservoir RS.

And, when the second master piston MP2 is advanced from its initial position by the first stroke dl (port idle) or more, the opening area of the port P6 is closed by the seal member S1, thereby to block the communication between the second master chamber C2 and the atmospheric pressure chamber C3. Likewise, when the first master piston MP1 is advanced from its initial position by the first stroke dl (port idle) or more, the opening area of the port P5 is closed by the seal member S3, thereby to block the communication between the first master chamber Cl and the atmospheric pressure chamber C4. And, when the second master piston MP2 is advanced from its initial position by the second stroke d2 or more, the communication hole P8 is separated from the atmospheric pressure chamber C6 of the stroke simulator AB by the seal member s5, whereby the communication between the atmospheric pressure chamber C6 and the reservoir RS is blocked.

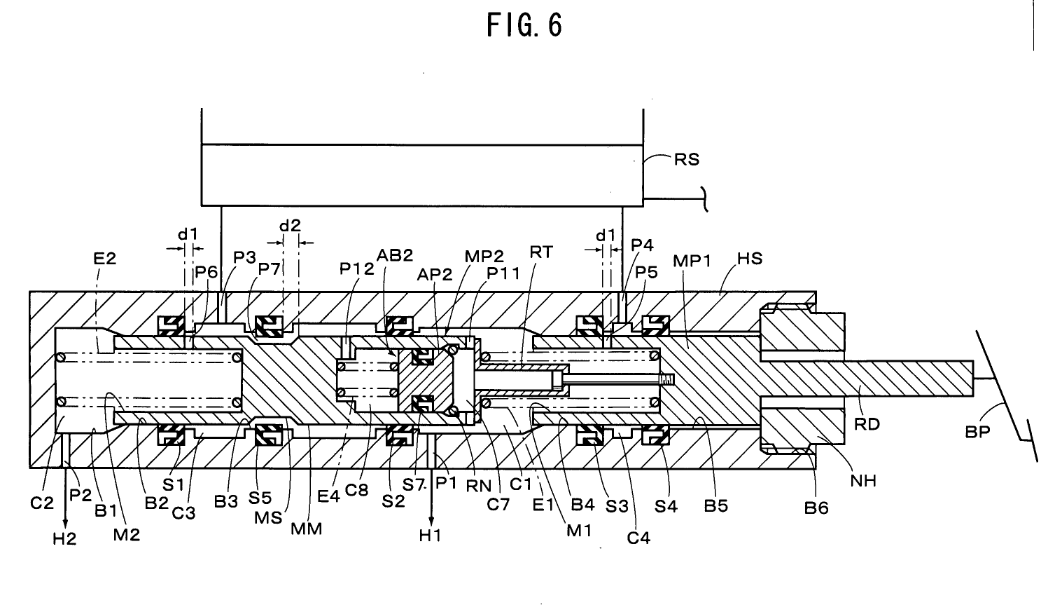

FIG. 6 shows a further embodiment of the present invention, wherein a stroke simulator AB2 is accommodated in the second master piston MP2, and wherein structural elements equivalent to those described in FIG. 1 are designated by corresponding reference numerals. Therefore, the second master piston MP2 is formed with the communication passage P7 as shown in FIG. l, which may include the communication grooves P71 as shown in FIG. 3, the cut-out sections P72 as shown in FIG. 4, and the communication hole P8 as shown in FIG. 5. According to the present embodiment, the stroke simulator AB2 includes a piston member AP2, which is fluid-tightly and slidably received through a seal member S7 in a cylindrical bore formed in the second master piston MP2 to be opened rearward, and which is urged rearward by a compression spring E4. At a rear end portion of the piston member AP2, fixed is a ring member RN to restrict its rear most position, so that a simulator hydraulic pressure chamber C7 (hereinafter simply referred to as simulator pressure chamber C7) is defined to be opened rearward of the piston member AP2 and communicated with the first master chamber C1, and a simulator atmospheric pressure chamber C8 (hereinafter simply referred to as atmospheric pressure chamber C8) is defined in front of the piston member AP2. Although it is so constituted that the simulator pressure chamber C7 is always communicated with the first master chamber C1 through the port P11 as shown in FIG. 6, both of the chambers C1 and C7 are substantially provided by a single chamber. On the side wall of the second master piston MP2, there is formed a port P12 communicated with the atmospheric pressure chamber C8, so that the atmospheric pressure chamber C8 can be communicated with the atmospheric pressure chamber C3 through the communication passage P7.

According to the present embodiment, therefore, when the second master piston MP2 is placed in its initial position as shown in FIG. 6, the small diameter portion MS is faced with the seal member S5, so that the atmospheric pressure chamber C8 of the stroke simulator AB2 is communicated with the atmospheric pressure chamber C3 through the communication passage P7 (or, the communication grooves P71 in FIG. 3, cut-out sections P72 in FIG. 4, communication hole P8 in FIG. 5) and finally communicated with the reservoir RS. And, when the second master piston MP2 is advanced from its initial position by the first stroke dl (port idle) or more, the opening area of the port P6 is closed by the seal member S1, thereby to block the communication between the second master chamber C2 and the atmospheric pressure chamber C3 (in this case, the atmospheric pressure chamber C8 is communicated with the atmospheric pressure chamber C3 through the communication passage P7 and finally communicated with the reservoir RS). Likewise, when the first master piston MP1 is advanced from its initial position by the first stroke dl (port idle) or more, the opening area of the port P5 is closed by the seal member S3, thereby to block the communication between the first master chamber C1 and the atmospheric pressure chamber C4.

With the first master piston MP1 being advanced, the piston member AP2 is pushed against the biasing force of the compression spring E4 to provide the stroke of the first master piston MP1. Thereafter, as the atmospheric pressure chamber C8 will be communicated with the atmospheric pressure chamber C3 through the communication passage P7 and finally communicated with the reservoir RS, the piston member AP2 or the like will be moved to act as the stroke simulator, until the second master piston MP2 will be advanced from its initial position by the predetermined distance (second stroke d2) to contact the seal member S5 with its main body portion MM. And, when the second master piston MP2 is advanced from its initial position by the second stroke d2 or more, the port P7 is separated from the atmospheric pressure chamber C8 by the seal member S5, whereby the communication between the atmospheric pressure chamber C8 and the reservoir RS is blocked.

According to the present embodiment, therefore, in the case where the pressure control device PC as shown in FIG. 2 is normal, the switching valves NO1 and N02 are energized to be placed in their closed positions, so that the second master piston MP2 is not advanced more than the first stroke dl, but only the first master piston MP1 is advanced, so that the piston member AP2 or the like will be moved to act as the stroke simulator. In the case where the pressure control device PC comes to be abnormal, the switching valves NO1 and N02 are placed in their open positions, so that the hydraulic pressure circuits Hi and H2 are in their communicated states. Consequently, the first and second master pistons MP1 and MP2 are advanced almost equally, and when the second master piston MP2 is advanced from its initial position by the second stroke d2 or more, the communication between the atmospheric pressure chamber C8 and the reservoir RS is blocked by the seal member S5, so that the piston member AP2 will not be moved, and the hydraulic pressure will be discharged from the first and second master chambers C1 and C2 to the hydraulic pressure circuits H1 and H2 in response to advancing operation of the first and second master pistons MP1 and MP2.

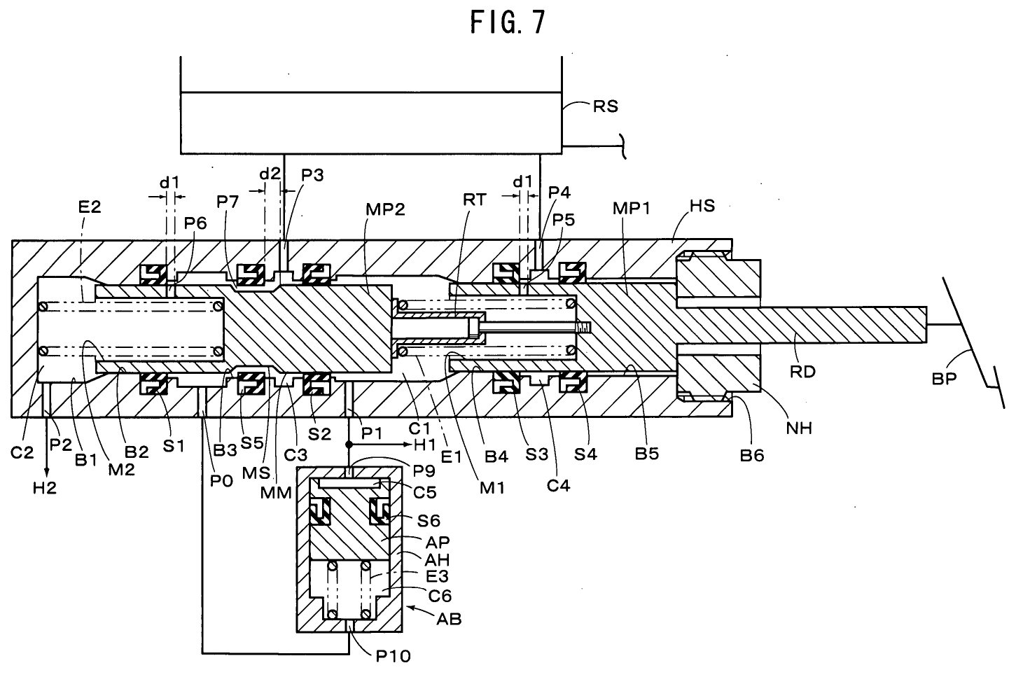

FIG. 7 shows a yet further embodiment of the present invention, wherein, comparing with the embodiment as shown in FIG. 1, the ports P0 and P3 are formed to be opened at different positions from those as shown in FIG. 1, the seal member S5, which is provided for acting as the communication control device together with the communication passage P7, is placed so that its opening end of the cup-like cross section is faced in a direction opposite to the direction as shown in FIG. 1. The other structural elements are substantially the same as those in FIG. 1, so that the structural elements equivalent to those as described in FIG. 1 are designated by corresponding reference numerals, and those elements are arranged in the same manner as shown in FIG. 2.

According to the present embodiment, therefore, with the first master piston MP1 being advanced, the piston member AP is pushed against the biasing force of the compression spring E3, so that the stroke is given to the first master piston MP1. Thereafter, the atmospheric pressure chamber C6 will be communicated with the atmospheric pressure chamber C3 through the communication passage P7 (and, the ports P0 and P10) and finally communicated with the reservoir RS, to actuate the stroke simulator AB, until the second master piston MP2 will be advanced from its initial position by the predetermined distance (second stroke d2) so that its main body MM will contact the seal member S5. And, when the second master piston MP2 is advanced from its initial position by the second stroke d2 or more, the communication passage P7 is separated from the atmospheric pressure chamber C3 by the seal member S5, whereby the communication between the atmospheric pressure chamber C6 and the reservoir RS is blocked.

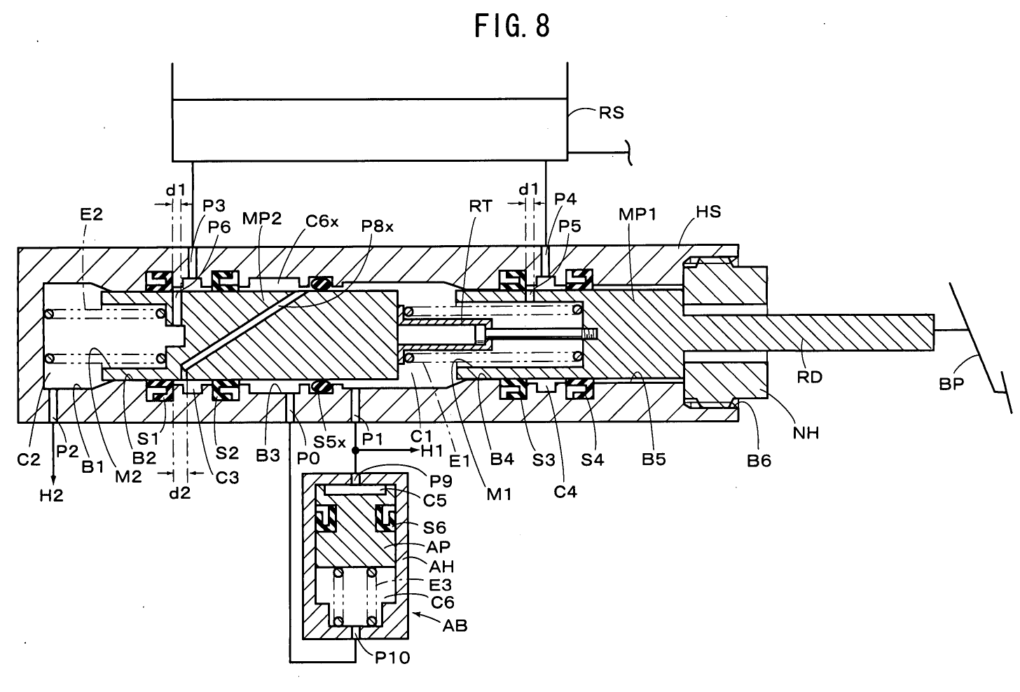

FIGS. 8-11 relate to the invention including the communication control device having a seal member disposed in the cylinder housing and applied with the hydraulic pressure in the second master pressure chamber when the simulator atmospheric pressure chamber is communicated with the reservoir, wherein structural elements equivalent to those described in FIGS. 1-7 are designated by corresponding reference numerals. Referring to FIG. 8, the housing HS is closed in its front end (left in FIG. 8) to be formed in a cylinder with a bottom, and formed with a cylinder bore having a recess B1, and a stepped bore of the small diameter bore B2, stepped large diameter bore B3, small diameter bore B4 and large diameter bore B5. At the rear end of the housing HS, there is formed the open end portion B6 with threaded grooves formed on its inner surface. On the inner wall of the cylinder bore, formed are annular grooves for holding annular seal members S1-S4 having a cup-like cross section, respectively, and annular seal member S5x having a circular cross section. The atmospheric pressure chamber C3 is defined between the annular seal members S1 and S2, and the atmospheric pressure chamber C4 is defined between the annular seal members S3 and S4. In addition, an atmospheric pressure chamber C6x is defined between the annular seal members S2 and S5x. On the side wall of the housing HS, there are formed the ports P0 and P1 opening into the front section and the rear section of the seal member S5x in the large diameter bore B3, respectively, the port P2 opening into the second master pressure chamber C2 in the recess B1, the port P3 opening into the atmospheric pressure chamber C3, and the port P4 opening into the atmospheric pressure chamber C4. The ports P3 and P4 are communicated with the (atmospheric pressure) reservoir RS.

As for the first master piston MP1, there are formed at its front end the recess M1 opening forward, and formed at its rear end the rod RD extending backward. On the side wall of the first master piston MP1, there is formed the port P5 opening into the recess M1. The second master piston MP2 is formed with the recess M2 opening forward, and formed with a communication hole P8x in a direction crossing the longitudinal axis of the second master piston MP2 (i.e., offset radial direction). Furthermore, on the side wall of the second master piston MP2, there is formed the port P6 opening into the recess M2. When the second master piston MP2 is placed in its initial position, therefore, the seal members S1, S2 and S5x are in contact with the outer peripheral surface of the portion of piston MP2 without the communication hole P8x being formed, the communication hole P8x is formed to be opened at the front section and rear section of the seal member S2 along the longitudinal axis, as shown in FIG. 8, so that the atmospheric pressure chamber C6x is communicated with the atmospheric pressure chamber C3, and finally communicated with the reservoir RS.

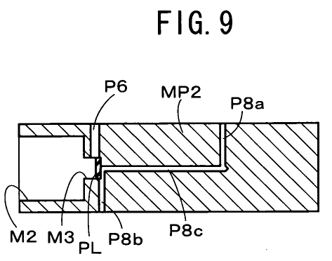

As shown in FIG. 8, the communication hole P8x is formed to be inclined by a certain angle against the longitudinal axis of the second master piston MP2, to provide the communication hole formed in the direction crossing the longitudinal axis according to the present invention. In contrast, it may be so constituted as shown in FIG. 9 that a pair of holes P8a and P8b are formed in a radial direction perpendicular to the longitudinal axis of the second master piston MP2, and a hole P8c is formed along the longitudinal axis for connecting the holes P8a and P8b, and closed by a plug member PL. With the holes P8a, P8b and P8c, therefore, the communication hole is formed substantially in the direction crossing the longitudinal axis, to act as the communication hole P8x as shown in FIG. 8. As shown in FIG. 9, the second master piston MP2 is formed with a recess M3 for the convenience in forming the hole P8c, and the plug member PL is fitted into the recess M3 to close the opening end of the hole P8c.

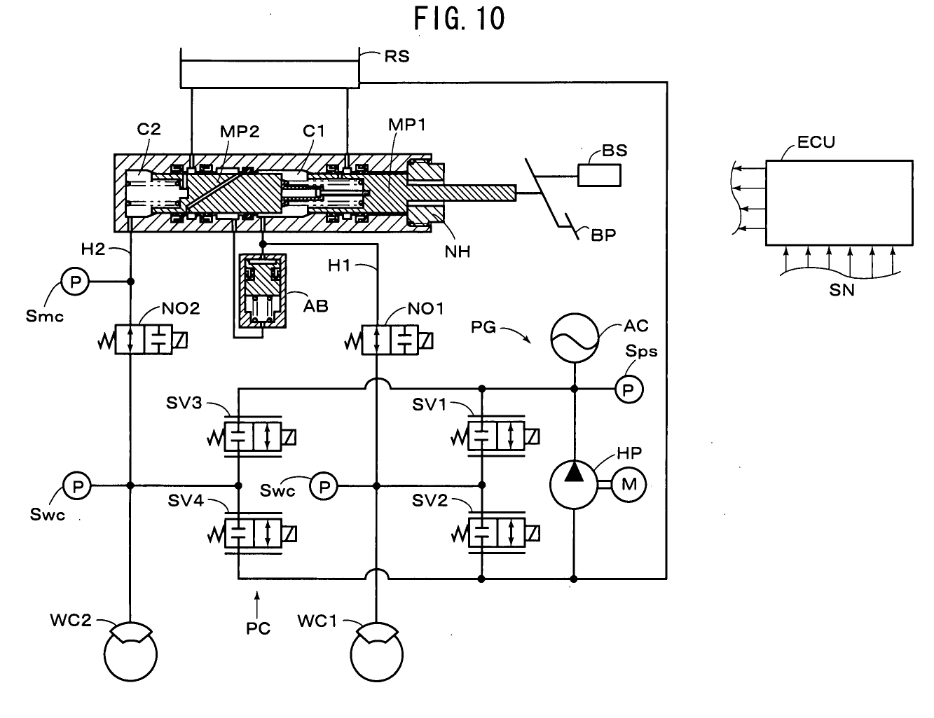

According to the present embodiment, the same stroke simulator AB as the one as shown in FIG. 1 is disposed to communicate its simulator pressure chamber C5 with the first master chamber C1 through the port P1, and communicate its atmospheric pressure chamber C6 with the atmospheric pressure chamber C6x through the port P0. And, the parts of the master cylinder as shown in FIG. 8 are assembled in substantially the same manner as described before, so that the explanation is omitted herein. The first master chamber Cl and the second master chamber C2 are defined in front of the first master piston MP1 and second master piston MP2, respectively, in the housing HS, to be communicated with the wheel brake cylinder WC1 and WC2 as shown in FIG. 10, through the ports P1 and P2 via hydraulic pressure circuits H1 and H2, respectively. And, when the first and second master pistons MP1 and MP2 are placed in their initial positions as shown in FIG. 8, the first and second master chambers C1 and C2 are communicated with the atmospheric pressure chambers C4 and C3 through the ports P5 and P6, and finally communicated with the reservoir RS through the ports P4 and P3, respectively.

When the second master piston MP2 is placed in its initial position as shown in FIG. 8, the seal members S1, S2 and S5x are in contact with the outer peripheral surface of the part of the main body portion without the communication hole P8x being formed therein, so that the atmospheric pressure chamber C3 is communicated with the atmospheric pressure chamber C6 of the stroke simulator AB, through the communication hole P8x and the atmospheric pressure chamber C6x (and, the ports P0 and P10). The first master pressure chamber C1 is always communicated with the simulator pressure chamber C5 through the ports P1 and P9. And, when the second master piston MP2 is advanced from its initial position by the first stroke d1 (port idle) or more, the opening area of the port P6 is closed by the seal member S1, thereby to block the communication between the second master chamber C2 and the atmospheric pressure chamber C3. Likewise, when the first master piston MP1 is advanced from its initial position by the first stroke d1 (port idle) or more, the opening area of the port P5 is closed by the seal member S3, thereby to block the communication between the first master chamber C1 and the atmospheric pressure chamber C4.

With the first master piston MP1 being advanced, the piston member AP is pushed against the biasing force of the compression spring E3 to provide the stroke of the first master piston MP1. Thereafter, the pressure chamber C6 of the stroke simulator AB will be communicated with the atmospheric pressure chamber C3 through the ports P10 and P0, the atmospheric pressure chamber C6x and the communication hole P8x, and finally with the reservoir RS, to act as the stroke simulator AB, until the second master piston MP2 will be advanced from its initial position by the predetermined distance (second stroke d2) to contact the seal member S1 at its whole outer peripheral surface including the communication hole P8x. And, when the second master piston MP2 is advanced from its initial position by the second stroke d2 or more, the communication hole P8x is separated from the atmospheric pressure chamber C3 by the seal member S1, whereby the communication between the atmospheric pressure chamber C6 and the reservoir RS is blocked. According to the present embodiment, therefore, the communication hole P8x and the seal member S1 constitute the communication control device of the present invention.

The hydraulic braking pressure generating apparatus according to the present embodiment is provided to constitute the hydraulic brake apparatus as shown in FIG. 10, in substantially the same manner as shown in FIG. 2, so that the explanation of it is omitted herein. And, the hydraulic brake apparatus operates in substantially the same manner as the embodiment as shown in FIG. 2. In the case where the pressure control device PC including the pressure source PG and the like comes to be abnormal, the switching valves NO1 and NO2 are de-energized (turned off) to be placed in their open positions, so that the hydraulic pressure circuits H1 and H2 are in their communicated states as shown in FIG. 10. At the same time, the first linear solenoid valves SV1 and SV3, and the second linear solenoid valves SV2 and SV4 are de-energized (turned off) to be placed in their closed positions, respectively, so that the hydraulic pressure will not be supplied from the pressure source PG to the wheel brake cylinders WC1 and WC2. In this state, therefore, when the brake pedal BP is depressed, to advance the second master piston MP2 by the second stroke (d2) or more from the initial position in response to operation of the brake pedal BP, its whole outer peripheral surface including the opening end of the communication hole P8x will contact the seal member S1, to block the communication between the atmospheric pressure chamber C6 of the stroke simulator AB and the reservoir RS, whereby the piston member AP will not move.

And, when the second master piston MP2 is advanced further, the hydraulic pressure in the second master chamber C2 is transmitted to the atmospheric pressure chamber C6, whereby the piston member AP is retracted to its initial position by means of the biasing force of the compression spring E3. Consequently, without the stroke simulator AB being operated, the first and second master pistons MP1 and MP2 will be advanced to compress the first and second master chambers C1 and C2, respectively, thereby to discharge the hydraulic pressure to the hydraulic pressure circuits H1 and H2 in response to operation of the brake pedal BP.

Furthermore, according to the present embodiment, it is so constituted that the seal member S1 is applied with the hydraulic pressure in the second master chamber C2, even in such a state that the atmospheric pressure chamber C6 of the stroke simulator AB is being communicated with the reservoir RS. Therefore, when the braking operation is performed by the vehicle driver to move the second master piston MP2, the hydraulic pressure is generated in the second master chamber C2, so that the hydraulic pressure is applied to the seal member S1. Therefore, even in the case where the pressure source PG or the like is normal, if the seal member S1 has been damaged in its sealing property, the vehicle driver can feel the damage of the seal member S1, because no reaction force is created in response to braking operation of the vehicle driver due to insufficiency of the sealing property.

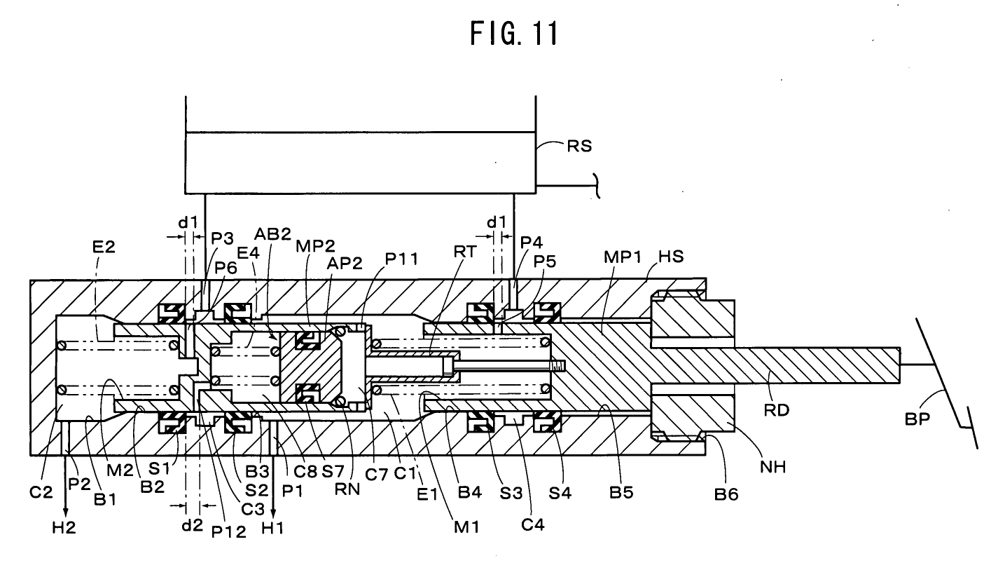

FIG. 11 shows a yet further embodiment of the present invention, wherein the stroke simulator AB2 is accommodated in the second master piston MP2, and wherein structural elements equivalent to those described in FIG. 8 are designated by corresponding reference numerals. And, comparing with the embodiment as shown in FIG. 6, the port P7 and seal member S5 are not provided in the present embodiment as shown in FIG. 11, and the port P11 and the port (passage) P12 are opened at different positions from those in FIG. 6. According to the present embodiment, therefore, the stroke simulator AB2 includes the piston member AP2, which is fluid-tightly and slidably received through the seal member S7 in the cylindrical bore formed to be opened rearward of the second master piston MP2, and which is urged rearward by the compression spring E4. The rear end of the piston member AP2 is restricted by a ring member RN, so that the simulator pressure chamber C7 is defined to be opened rearward of the piston member AP2, to be communicated with the first master chamber C1, and the atmospheric pressure chamber C8 is defined in front of the piston member AP2. Furthermore, on the side wall of the second master piston MP2, there is formed a passage P12 for communicating the atmospheric pressure chamber C3 with the atmospheric pressure chamber C8. Although it is so constituted that the simulator pressure chamber C7 is always communicated with the first master chamber C1 through the port P11 as shown in FIG. 11, both of the chambers C1 and C7 are substantially provided by a single chamber.

Accordingly, when the second master piston MP2 is placed in its initial position as shown in FIG. 11, the atmospheric pressure chamber C8 of the stroke simulator AB2 is communicated with the atmospheric pressure chamber C3 through the passage P12, and finally with the reservoir RS. And, when the second master piston MP2 is advanced from its initial position by the first stroke d1 (port idle) or more, the opening area of the port P6 is closed by the seal member S1, thereby to block the communication between the second master chamber C2 and the atmospheric pressure chamber C3 (in this case, the atmospheric pressure chamber C8 is communicated with the atmospheric pressure chamber C3 through the passage P12, and finally with the reservoir RS). Likewise, when the first master piston MP1 is advanced from its initial position by the first stroke d1 (port idle) or more, the opening area of the port P5 is closed by the seal member S3, thereby to block the communication between the first master chamber C1 and the atmospheric pressure chamber C4.

With the first master piston MP1 being advanced, the piston member AP2 is pushed against the biasing force of the compression spring E4 to provide the stroke of the first master piston MP1. Thereafter, the atmospheric pressure chamber C8 of the stroke simulator AB2 will be communicated with the atmospheric pressure chamber C3 through the passage P12, and finally with the reservoir RS, to act as the stroke simulator, until the second master piston MP2 will be advanced from its initial position by the predetermined distance (second stroke d2) to contact the seal member S1 at its whole outer peripheral surface including the passage P12. And, when the second master piston MP2 is advanced from its initial position by the second stroke d2 or more, the passage P12 is separated from the atmospheric pressure chamber C8 by the seal member S1, whereby the communication between the atmospheric pressure chamber C8 and the reservoir RS is blocked, whereby the piston member AP2 will not move. And, when the second master piston MP2 is advanced further, the hydraulic pressure in the second master chamber C2 is transmitted to the atmospheric pressure chamber C8, whereby the piston member AP2 is retracted to its initial position by means of the biasing force of the compression spring E4. Consequently, without the stroke simulator AB2 being operated, the first and second master pistons MP1 and MP2 will be advanced to compress the first and second master chambers C1 and C2, respectively. Also, on the side wall of the second master piston MP2, there is formed a passage P12 for communicating the atmospheric pressure chamber C3 with the atmospheric pressure chamber C8, so that the atmospheric pressure chamber C8 can be communicated with the atmospheric pressure chamber C3 through the passage P12. That is, the passage P12 constitutes the communication passage formed in the direction crossing the longitudinal axis of the second master piston MP2, to act as the communication hole P8x in FIG. 8.

According to the present embodiment, therefore, in the case where the pressure control device PC as shown in FIG. 10 is normal, the switching valves NO1 and NO2 are energized to be placed in their closed positions, so that the second master piston MP2 is not advanced more than the first stroke d1, but only the first master piston MP1 is advanced, so that the piston member AP2 or the like will be moved to act as the stroke simulator. In the case where the pressure control device PC comes to be abnormal, the switching valves NO1 and NO2 are placed in their open positions, so that the hydraulic pressure circuits H1 and H2 are in their communicated states. Consequently, the first and second master pistons MP1 and MP2 are advanced almost equally, and when the second master piston MP2 is advanced from its initial position by the second stroke d2 or more, the piston member AP2 is not be moved, and the hydraulic pressure is discharged to the hydraulic pressure circuits H1 and H2 in response to advancing operation of the first and second master pistons MP1 and MP2. Furthermore, when the braking operation is performed by the vehicle driver to move the second master piston MP2, the hydraulic pressure is generated in the second master chamber C2, so that the hydraulic pressure is applied to the seal member S1. Therefore, even in the case where the pressure source PG or the like is normal, if the seal member S1 has been damaged in its sealing property, the vehicle driver can feel the damage of the seal member S1.

It should be apparent to one skilled in the art that the above-described embodiments are merely illustrative of but one of the many possible specific embodiments of the present invention. Numerous and various other arrangements can be readily devised by those skilled in the art without departing from the spirit and scope of the invention as defined in the following claims.

1. A hydraulic braking pressure generating apparatus for vehicles, comprising:
a first piston member slidably accommodated in a cylinder housing to be moved back and forth in response to operation of a manually operated braking member;
a second piston member slidably accommodated in said cylinder housing for defining a first master pressure chamber between said first piston member and said second piston member, and defining a second master pressure chamber between said second piston member and said cylinder housing;
a stroke simulator having a simulator pressure chamber communicated with said first master pressure chamber, a simulator atmospheric pressure chamber communicated with an atmospheric pressure reservoir, and a piston member urged by a resilient member toward said simulator pressure chamber, said stroke simulator absorbing brake fluid of an amount determined in response to the hydraulic pressure discharged from said first master pressure chamber, to provide a stroke for said first piston member in response to braking operation force of said manually operated braking member;
communication control means for communicating said simulator atmospheric pressure chamber with said atmospheric pressure reservoir when said second piston member is placed in an initial position thereof, and blocking the communication between said simulator atmospheric pressure chamber and said atmospheric pressure reservoir, when said second piston member is advanced by a predetermined distance or more from the initial position thereof,
wherein said communication control means includes a seal member disposed in said cylinder housing, and a communication passage formed on said second piston member, and wherein said communication control means communicates said simulator atmospheric pressure chamber with said atmospheric pressure reservoir through said communication passage, when said second piston member is placed in the initial position thereof, and said communication control means separates said communication passage from one of said simulator atmospheric pressure chamber and said atmospheric pressure reservoir by said seal member, when said second piston member is advanced from the initial position thereof by the predetermined distance or more, to block the communication between said simulator atmospheric pressure chamber and said atmospheric pressure reservoir.

2. A hydraulic braking pressure generating apparatus for vehicles as set forth in claim 1, wherein said second piston member is formed with a small diameter portion to provide a step between a main body portion of said second piston member and said small diameter portion, and wherein a clearance is formed by said step to provide said communication passage.

3. A hydraulic braking pressure generating apparatus for vehicles as set forth in claim 1, wherein said communication passage includes a longitudinal communication groove formed around a part of the outer peripheral surface of said second piston member.

4. A hydraulic braking pressure generating apparatus for vehicles as set forth in claim 1, wherein said communication passage includes a longitudinal cut-out section formed around a part of the outer peripheral surface of said second piston member.

5. A hydraulic braking pressure generating apparatus for vehicles as set forth in claim 1, wherein said communication passage includes a communication hole formed to penetrate said second piston member in a direction crossing a longitudinal axis thereof.

6. A hydraulic braking pressure generating apparatus for vehicles as set forth in claim 1, wherein said stroke simulator is accommodated in said second piston member.

7. A hydraulic braking pressure generating apparatus for vehicles as set forth in claim 6, wherein said second piston member is formed with a small diameter portion to provide a step between a main body portion of said second piston member and said small diameter portion, and wherein a clearance is formed by said step to provide said communication passage.

8. A hydraulic braking pressure generating apparatus for vehicles as set forth in claim 6, wherein said communication passage includes a longitudinal communication groove formed around a part of the outer peripheral surface of said second piston member.

9. A hydraulic braking pressure generating apparatus for vehicles as set forth in claim 6, wherein said communication passage includes a longitudinal cut-out formed around a part of the outer peripheral surface of said second piston member.

10. A hydraulic braking pressure generating apparatus for vehicles as set forth in claim 6, wherein said communication passage includes a communication hole formed to penetrate said second piston member in a direction crossing a longitudinal axis thereof.

11. A hydraulic braking pressure generating apparatus for vehicles, comprising:
a first piston member slidably accommodated in a cylinder housing to be moved back and forth in response to operation of a manually operated braking member;
a second piston member slidably accommodated in said cylinder housing for defining a first master pressure chamber between said first piston member and said second piston member, and defining a second master pressure chamber between said second piston member and said cylinder housing;
a stroke simulator having a simulator pressure chamber communicated with said first master pressure chamber, a simulator atmospheric pressure chamber communicated with an atmospheric pressure reservoir, and a piston member urged by a resilient member toward said simulator pressure chamber, said stroke simulator absorbing brake fluid of an amount determined in response to the hydraulic pressure discharged from said first master pressure chamber, to provide a stroke for said first piston member in response to braking operation force of said manually operated braking member;
communication control means for communicating said simulator atmospheric pressure chamber with said atmospheric pressure reservoir when said second piston member is placed in an initial position thereof, and blocking the communication between said simulator atmospheric pressure chamber and said atmospheric pressure reservoir, when said second piston member is advanced by a predetermined distance or more from the initial position thereof,
wherein said communication control means includes a seal member disposed in said cylinder housing and applied with the hydraulic pressure in said second master pressure chamber when said simulator atmospheric pressure chamber is communicated with said reservoir, and a communication hole formed to penetrate said second piston member in a direction crossing a longitudinal axis thereof, and wherein said communication control means communicates said simulator atmospheric pressure chamber with said atmospheric pressure reservoir through said communication hole, when said second piston member is placed in the initial position thereof, and said communication control means separates said communication hole from one of said simulator atmospheric pressure chamber and said atmospheric pressure reservoir by said seal member, when said second piston member is advanced from the initial position thereof by the predetermined distance or more, to block the communication between said simulator atmospheric pressure chamber and said atmospheric pressure reservoir.

12. A hydraulic braking pressure generating apparatus for vehicles as set forth in claim 11, wherein said stroke simulator is accommodated in said second piston member.
